(19) United States
(12) Patent Application Publication
(10) Pub. No.: US 2008/0272713 A1
(43) Pub. Date: Nov. 6, 2008

(54) Driving Circuit of Organic Light Emitting Diode Display Panel and Discharging Method Using the Same

(75) Inventors: Seen Suk Kang, Seoul (KR); Seong Ik Jeong, Seoul (KR)

Correspondence Address: CANTOR COLBURN, LLP, 20 Church Street, 22nd Floor, Hartford, CT, 06103, US

(73) Assignee: SYNCOAM CO., LTD, Seongnam City (KR)

(21) Appl. No.: 12/089,506

(22) PCT Filed: Sep. 20, 2006
(86) PCT No.: PCT/KR2006/003726

§ 371 Date: Apr. 7, 2008

(30) Foreign Application Priority Data
Oct. 18, 2005 (KR) 10-2005-0097928

(51) Int. Cl. H05B 41/36; G09G 3/26

(52) U.S. Cl. 315/291; 345/82

(57) ABSTRACT

There is provided a driving circuit using an internal diode instead of a zener diode and a discharging method using the same capable of replacing a driving circuit including an external zener diode, thereby reducing costs.

The driving circuit using a discharging method for driving an OLED (organic light emitting diode) panel, the driving circuit includes: a precharge channel which is constructed in a current mirror scheme and is turned off when discharging; a discharge channel which is connected to the to precharge channel in series and operates when discharging; and an internal diode which is connected to the discharge channel and controls a discharge voltage level.

According to the present invention, a voltage level can be controlled not to be discharged to a ground level by using an internal diode circuit when discharging. Therefore, a driving circuit requiring low power can be implemented, and additional costs are not needed.

### TECHNICAL FIELD

The present invention relates to an organic light emitting diode (OLED), and more particularly, to a driving circuit of an OLED.

### BACKGROUND ART

As an image display apparatus for TVs, computers, or mobile phones, a liquid crystal display (LCD) has been widely used. However, since the LCD needs a backlight, there are problems in that, the LCD is heavy-weight and thick, and a response speed thereof is slow. As a next generation image display apparatus replacing the LCD, an organic light emitting diode (OLED) display panel has been proposed. The OLED panel includes an organic thin film having a very thin thickness less than 0.1 μm.

When a current is passed through the organic thin film, an electron and a hole recombine near the interface between an electron transport layer and a hole transport layer to emit light. The light emission has a very fast response speed less than hundreds of nanoseconds.

The OLED is constructed with two electrodes: an anode and a cathode, similarly to an inorganic light emitting diode. Due to voltage and current differences between individual OLEDs constituting the panel, current drives.

FIG. 1 is a view showing a current driving mode of a conventional OLED panel to explain a discharging method of the OLED panel according to an embodiment of the present invention.

A current precharge channel using a current mirror, a discharge channel connected to the precharge channel, and a zener diode for adjusting a voltage level of the discharge channel are connected.

FIG. 2 is a graph showing a discharge voltage level which is adjusted by a zener diode.

In the discharging method of adjusting a voltage level by the zener diode as shown in FIGS. 1 and 2, the external zener diode is added to the driving circuit. Therefore, costs increase.

### DETAILED DESCRIPTION OF THE INVENTION

### Technical Goal of the Invention

In order to solve the aforementioned problems, an object of the present invention is to provide a driving circuit using an internal diode instead of a zener diode and a discharging method using the same capable of replacing a driving circuit including an external zener diode, thereby reducing costs.

### DISCLOSURE OF THE INVENTION

According to an aspect of the present invention, there is provided a driving circuit using a discharging method for driving an organic light emitting diode (OLED) panel, the driving circuit including: a precharge channel which is constructed in a current mirror scheme and is turned off when discharging; a discharge channel which is connected to the precharge channel in series and operates when discharging; and an internal diode which is connected to the discharge channel and controls a discharge voltage level.

According to another aspect of the present invention, there is provided a discharging method used in a driving circuit for driving an OLED panel, the discharging method including: connecting an internal diode to a front terminal or a back terminal of a discharge channel constructed with a metal oxide semiconductor (MOS) transistor; and controlling a discharge voltage level by the internal diode connected to the discharge channel.

### BRIEF DESCRIPTION OF THE DRAWINGS

The above and other features and advantages of the present invention will become more apparent by describing in detail exemplary embodiments thereof with reference to the attached drawings in which:

FIG. 1 is a view showing a current driving mode of a conventional organic light emitting diode (OLED) panel to explain a discharging method of the OLED panel.

FIG. 2 is a graph showing a discharge voltage level which is adjusted by a zener diode.

FIG. 3 is a view showing a driving circuit of an OLED panel according to an embodiment of the present invention;

FIG. 4 is a graph showing a discharge voltage level which is adjusted by an internal diode; and

FIGS. 5 to 7 are embodiments showing a structure of an internal diode employed by a driving circuit of an OLED according to the present invention.

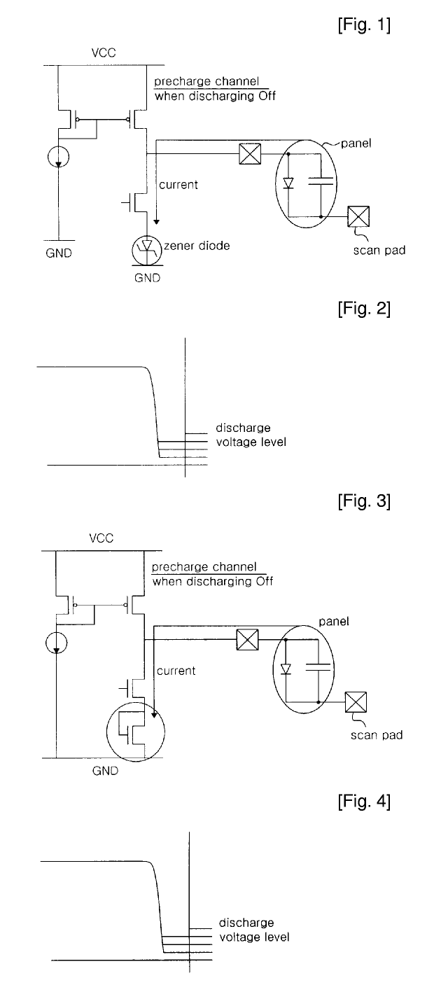

### BEST MODE FOR CARRYING OUT THE INVENTION

Hereinafter, the present will be described in detail with reference to accompanying drawings.

FIG. 3 is a view showing a driving circuit of an organic light emitting diode (OLED) panel to explain a discharging method used in the OLED panel according to an embodiment of the present invention.

A current precharge channel using a current mirror, a discharge channel connected to the precharge channel, and an internal diode for adjusting a voltage level of the discharge channel are connected.

The internal diode may be constructed with a metal-oxide semiconductor (MOS) transistor. A gate terminal and a drain terminal of the MOS transistor are connected to be used.

FIG. 4 is a graph showing a discharge voltage level which is adjusted by the internal diode.

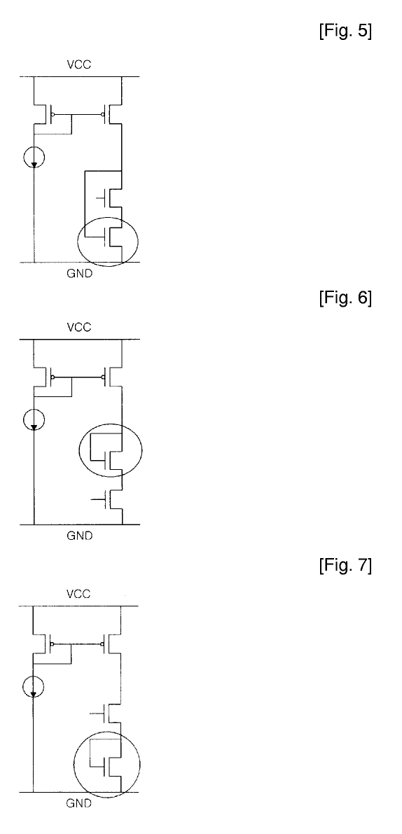

FIGS. 5 to 7 are embodiments showing a structure of the internal diode employed by a driving circuit of an OLED according to the present invention.

FIG. 5 shows an embodiment in that, the MOS transistor constituting the internal diode is connected to a back terminal of the discharge channel in series, and the gate terminal of the MOS transistor constituting the internal diode is connected to a drain terminal of the MOS transistor of the discharge channel.

FIG. 6 shows another embodiment in that, the internal diode is connected to a front terminal of the discharge channel in series, and the gate terminal and a drain terminal of the MOS transistor constituting the internal diode are connected.

FIG. 7 shows another embodiment in that, the internal diode is connected to the back terminal of the discharge channel in series, and the gate terminal and the drain terminal of the MOS transistor constituting the internal diode are connected.

While the present invention has been particularly shown and described with reference to exemplary embodiments thereof, it will be understood by those skilled in the art that various changes in form and details may be made therein without departing from the spirit and scope of the present invention as defined by the appended claims.

### INDUSTRIAL APPLICABILITY

According to the present invention, a voltage level can be controlled not to be discharged to a ground level by using an internal diode circuit when discharging. Therefore, a driving circuit requiring low power can be implemented, and additional costs are not needed.

1. A driving circuit using a discharging method for driving an OLED (organic light emitting diode) panel, the driving circuit comprising:
a precharge channel which is constructed in a current mirror scheme and is turned off when discharging;
a discharge channel which is connected to the precharge channel in series and operates when discharging; and
an internal diode which is connected to the discharge channel and so controls a discharge voltage level.

2. The driving circuit according to claim 1, wherein the internal diode is constructed by connecting a gate terminal and a drain terminal of a MOS (metal-oxide semiconductor) transistor.

3. The driving circuit according to claim 2,
wherein the internal diode is connected to a back terminal of the discharge channel in series, and
wherein the gate terminal of the MOS transistor constituting the internal diode is connected to a drain terminal of a MOS transistor of the discharge channel.

4. The driving circuit according to claim 2,
wherein the internal diode is connected to a front terminal of the discharge channel in series, and
wherein the gate terminal and the drain terminal of the MOS transistor constituting the internal diode are connected.

5. The driving circuit according to claim 2,
wherein the internal diode is connected to a back terminal of the discharge channel in series, and
wherein the gate terminal and the drain terminal of the MOS transistor constituting the internal diode are connected.

6. A discharging method used in a driving circuit for driving an OLED panel, the discharging method comprising.
(a) connecting an internal diode to a front terminal or a back terminal of a discharge channel constructed with a MOS transistor; and
(b) controlling a discharge voltage level by the internal diode connected to the discharge channel.

7. The discharging method according to claim 6, wherein the (b) comprising controlling the voltage level so as not to be discharged to a ground level when discharging.
